(19) United States
(12) Patent Application Publication
(10) Pub. No.: US 2008/0209829 A1
(43) Pub. Date: Sep. 4, 2008

(54) ANCHOR PLUG

(76) Inventor: Thomas E. Lucas, Clifton Park, NY (US)

Correspondence Address: HESLIN ROTHENBERG FARLEY & MESITI PC, 5 COLUMBIA CIRCLE, ALBANY, NY, 12203, US

(21) Appl. No.: 11/968,793

(22) Filed: Jan. 3, 2008

Related U.S. Application Data
(60) Provisional application No. 60/883,625, filed on Jan. 5, 2007.

(51) Int. Cl. E04B 1/66; G09F 3/18; G09F 13/04

(52) U.S. Cl. 52/302.7; 40/565; 40/660

(57) ABSTRACT

An anchor plug for use capping in-ground anchors is disclosed. The anchor plug may be used in capping masonry anchors located in pool decks, for example, capping the anchors used to retain pool covers. The anchor plug typically has a cylindrical body, for example, a hollow circular cylindrical body, having a first end and a second end; and a cap mounted to the first end of the cylindrical body. The cap may vary in thickness from a minimum at an edge of the cap to a maximum at about the center of the cap. The cap may include human readable indicia, such as, safety warnings or provider name. The anchor plug may minimize or prevent personal injury or damage to the anchor.

### CROSS-REFERENCE TO RELATED APPLICATIONS

This application claims priority from pending U.S. Provisional Patent Application 60/883,625 filed on Jan. 5, 2007, the disclosure of which is included by reference herein in its entirety.

### BACKGROUND OF THE INVENTION

1. Field of the Invention

The present invention generally relates to anchor plugs for capping in-ground anchors. More particularly, the present invention relates to anchor plugs used to cap anchors in pool decks used to retain pool covers to minimize or prevent personal injuries, to minimize or prevent damage to the anchor, to conceal the anchor, and/or to distinguish the anchor from the surroundings.

2. Description of Related Art

In-ground pools, and other structures, requiring protection from the elements, are typically covered during the winter months with a tarp or cover to protect the pool from the elements and prevent debris, animals, and small children from falling into the pool. Pool covers are typically secured to the surrounding deck by means of a multiple cords or lanyards secured to the deck. Typically, these cords are secured to anchors embedded the deck, for example, brass anchors embedded in the concrete deck surrounding the pool. This pool cover anchor securing arrangement is widely used and is an effective means for securing the pool cover.

However, when the cover is removed during normal use of the pool, the anchors embedded in the deck remain and provide an unsightly obstruction in the typically uniform appearance of the deck.

Aspects of the present invention, overcome the disadvantages of existing pool cover anchor technology by providing anchor plugs that conceal deck anchors thus providing a more aesthetically pleasing appearance of the surrounding deck.

### SUMMARY OF THE INVENTION

One aspect of the invention is an anchor plug adapted to be inserted into a masonry anchor. The anchor plug includes a cylindrical body having a first end and a second end; and a cap mounted to the first end of the cylindrical body. In one aspect, the cylindrical body comprises a hollow, circular cylindrical body. The cylindrical body may include at least one surface projection adapted to engage the inside surface of an anchor to ensure a snug fit. In another aspect, the thickness of the cap varies to a minimum at the edge of the cap. In another aspect, the cylindrical body comprises at least one relief groove. According to aspects of the invention, the anchor plug may minimize or prevent personal injuries, minimize or prevent damage to the anchor, conceal the anchor, and/or distinguish the anchor from the surroundings, for example, by utilizing color, human-readable indicia, or both. Aspects of the invention may be used during seasonal pool use, for instance, while in-ground anchors are not used to retain a pool cover.

Another aspect of the invention is a plug adapted to be inserted into any hole, for example, any hole that is it desirable to fill, protect, conceal, and/or distinguish from its surroundings. The hole plug may include a cylindrical body having a first end and a second end; and a cap mounted to the first end of the cylindrical body, and have one or more of the features described above and below for the anchor plug. Another aspect of the invention is the anchor plug or the hole plug as shown and described in the attached Figures.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of an anchor plug according to one aspect of the invention.

FIG. 2 is a side elevation view of the anchor plug shown in FIG. 1.

FIG. 3 is a top plan view of the anchor plug shown in FIG. 1.

FIG. 4 is a bottom view of the anchor plug shown in FIG. 1.

FIGS. 5A and 5B are cross sectional views of the anchor plug shown in FIG. 1 prior to installation and after installation in a typical anchor.

FIGS. 6A and 6B are perspective views of anchor plugs according to aspects of the invention, similar to FIG. 1, having typical graphics on the cap.

FIG. 7 is a side elevation view of the anchor plug shown in FIG. 6.

FIG. 8 is a top plan view of the anchor plug shown in FIG. 6.

FIG. 9 is a bottom view of the anchor plug shown in FIG. 6.

FIG. 10 is a plan view of a typical pool deck illustrating the environment in which aspects of the invention may be used.

### DETAILED DESCRIPTION OF DRAWINGS

The present invention comprises an anchor plug, for example, an anchor plug that is adapted to be inserted into a masonry anchor. Aspects of the invention provide a plug that safely covers anchors to enhance the aesthetic appearance of the surface into which the anchor is inserted, for example, a concrete pool deck or similar surface.

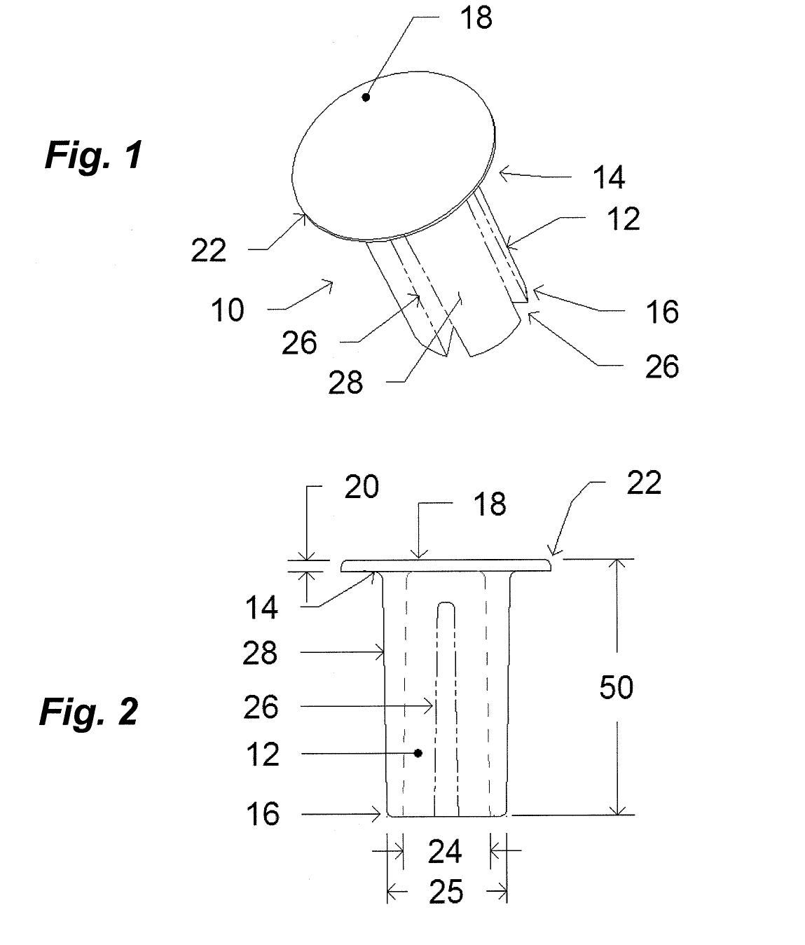

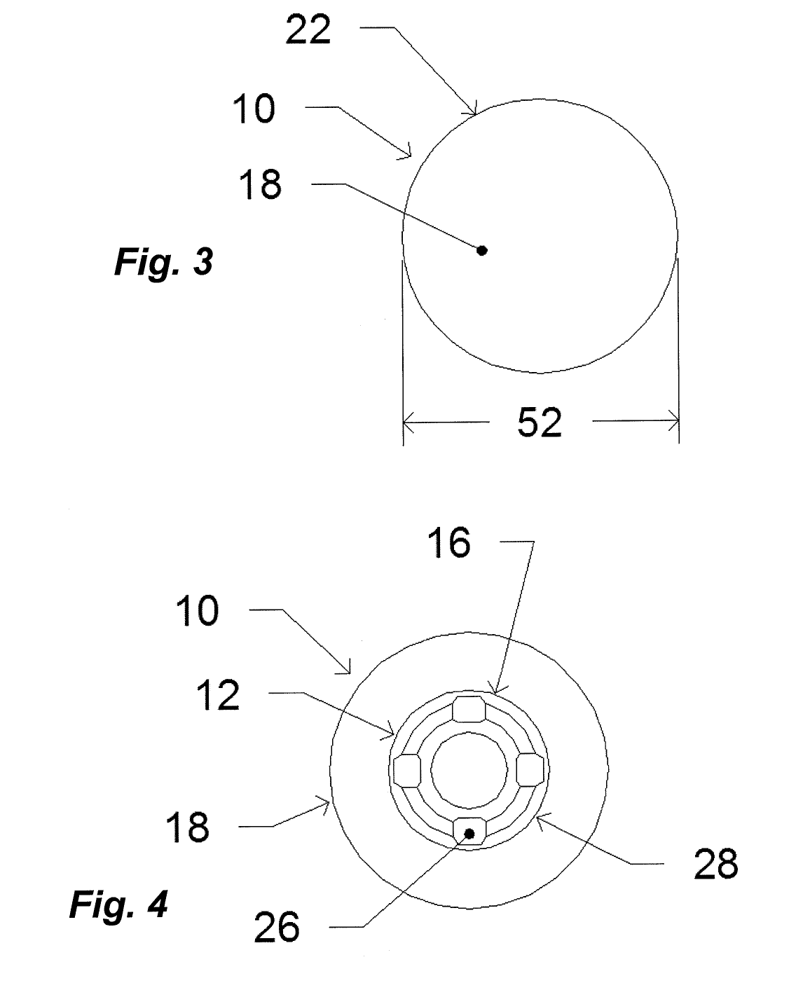

FIG. 1 is a perspective view of an anchor plug 10 according to one aspect of the invention. FIG. 2 is an elevation view of anchor plug 10 shown in FIG. 1; FIG. 3 is a top plan view of anchor plug 10 shown in FIG. 1; and FIG. 4 is a bottom view of anchor plug 10 shown in FIG. 1. As shown in FIGS. 1-4, anchor plug 10 includes a cylindrical body 12 having a first end 14 and a second end 16 and a cap 18 mounted to first end 14. According to the invention, cap 18 has a thickness 20 that varies to a minimum at an edge 22 of cap 18, for example, tapers to a minimum thickness. When anchor plug cap 18 is circular, the thickness the circular cap may typically vary radially, for example, from a maximum at the center of cap 18 to a minimum at outside edge or diameter 22. As shown in FIG. 2, the top surface of cap 18 may be substantially flat, though in on aspect, the top surface of cap 18 may be rounded, contoured, or textured.

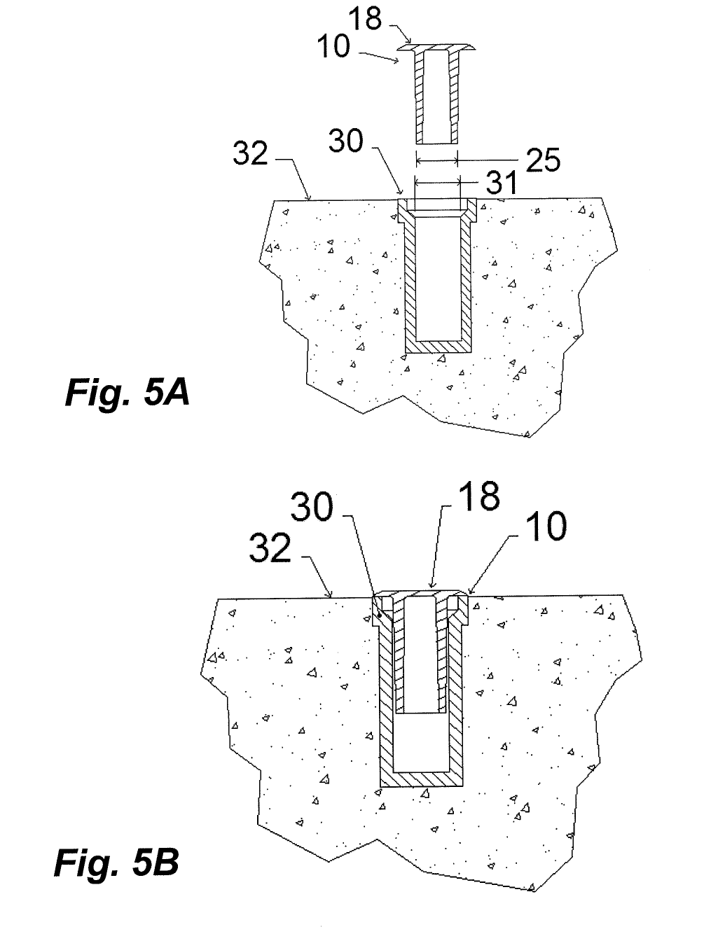

The variation in thickness of cap 18 minimizes the profile of cap 18 whereby when plug 10 is inserted into an anchor, for example, as shown in FIGS. 5A and 5B below, plug 10 substantially conceals the anchor while plug 10 blends in with the immediate surrounding deck surface. Though cap 18 may be circular as shown, in some aspects of the invention, cap 18 may also be non-circular, for example, oval, square, rectangular, or triangular, among other shapes. Regardless of shape, the thickness 20 of cap 18 preferably varies to a minimum thickness at edge 22.

As shown in FIG. 2, in one aspect, cylindrical body 12 comprises a hollow cylindrical body, for example, having inside diameter 24 and an outside diameter 25. Cylindrical body 12 may also include at least one relief groove 26, for example, to provide at least some resilience or flexibility to cylindrical body 12 whereby, when inserted into an anchor cavity, the resiliency of the cylindrical body 12 promotes at least some friction between the outside surface 28 of cylindrical body 12 and the inside diameter of the anchor cavity, see FIGS. 5A and 5B. Relief grooves 26 may have open first ends adjacent second end 16 of cylindrical body 12 and closed second ends, for example, radiused second ends, adjacent first end 14 of cylindrical body 12. Two, three, or more relief groves 26 may also be provided.

As shown in FIGS. 1-4, cylindrical body 12 may comprise a circular cylindrical body, specifically, a tapered circular cylindrical body, for example, that facilitates insertion into an anchor. The tapered cylindrical body 12 typically includes a first diameter at first end 14 and a second diameter, smaller than the first diameter, at the second end 16. The change in diameter, or taper, of the outside diameter of cylindrical body 12 may vary from about 0.5 degrees to about 10 degrees, but is typically about 2 degrees. In one aspect, cylindrical body 12 may be polygonal in cross-section, for example, pentagonal, hexagonal, octagonal.

FIGS. 5A and 5B are cross sectional views of anchor plug 10 shown in FIG. 1 prior to installation and after installation, respectively, in a typical anchor 30. As is typical, anchor 30 is installed in surface 32, for example, a concrete pool deck. However, according to aspects of the invention, surface 32 may be any horizontal surface, for example, a floor, or any vertical surface, for example, a wall. Surface 32 may be a poured concrete surface, a stamped concrete surface, a stone surface (for example, flagstone), a brick surface, an asphalt or macadam surface, a tile surface, or a wooden surface, among others. As shown in FIG. 5A, anchor 30 typically includes an inside diameter 31. When cylindrical body 12 is tapered, the outside diameter 25 of anchor plug 10 may more easily adapt to inside diameter 31 when inserted, for example, typically, manually inserted into anchor 30, though a tool may also be used, to firmly press fit plug 10 into anchor 30.

After insertion, as shown in FIG. 5B, plug 10 may be removed from anchor 30 by simply prying the underside of cap 18 of plug 10 from contact with the top of anchor 30. Plug 10 may also be twisted while prying to assist in disengaging plug 10 from anchor 30. Though a tool may not be necessary to remove plug 10, a thin bladed tool, for example, a flat screwdriver, may be used to assist in prying and removing plug 10 from anchor 30. For example, the blade of a screwdriver tip may be inserted between the underside of cap 18 and the top surface of anchor 30 and used to pry plug 10 from anchor 30. However, plug 10 may typically be removed by hand, that is, without the need for a tool.

As shown in FIG. 5B, upon installation, due to the varying thickness of cap 18, plug 10 provides a minimal profile above surface 32 whereby plug 10 provides visual continuity between the location of the anchor 30 and the surface 32. As shown in FIG. 5B, the outside diameter of cap 18 of plug 10 may typically be sized to conceal anchor 30. Though the outside diameter of cap 18, see outside diameter 52 in FIG. 3, may be larger or smaller than the outside diameter of the exposed top of anchor 30, preferably, the outside diameter 52 may be about equal to the outside diameter of the exposed top of anchor 30.

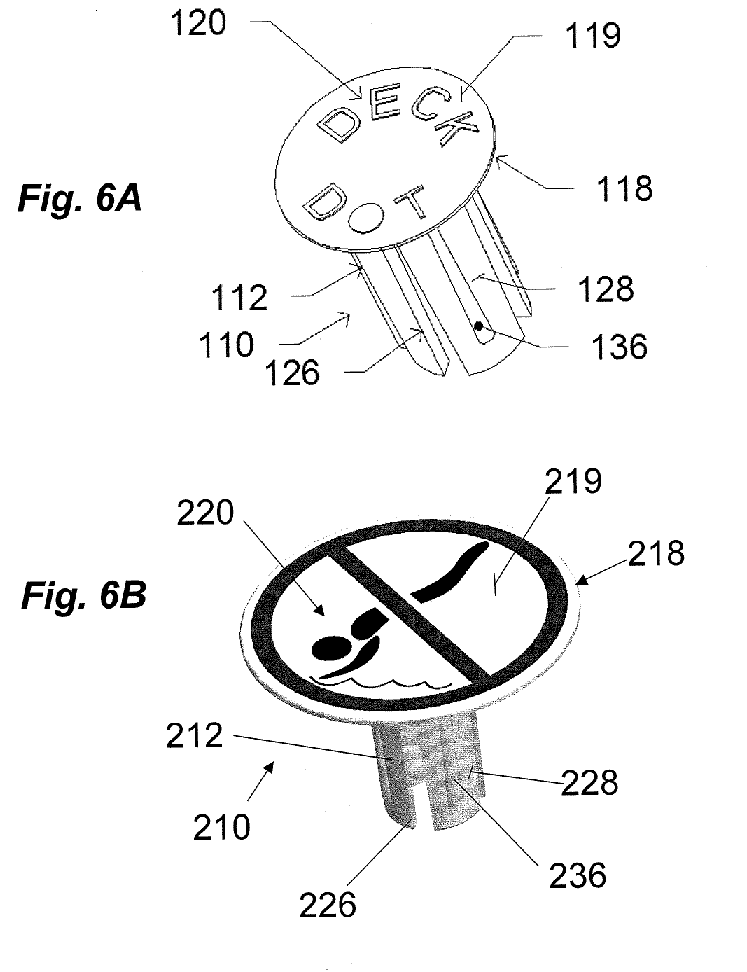

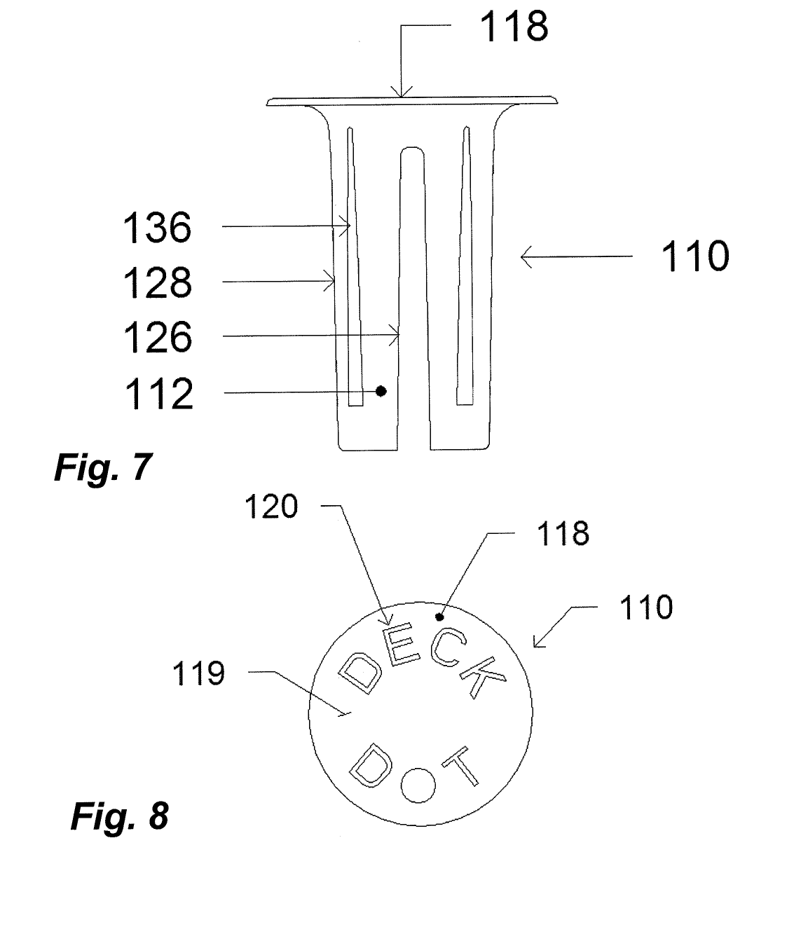

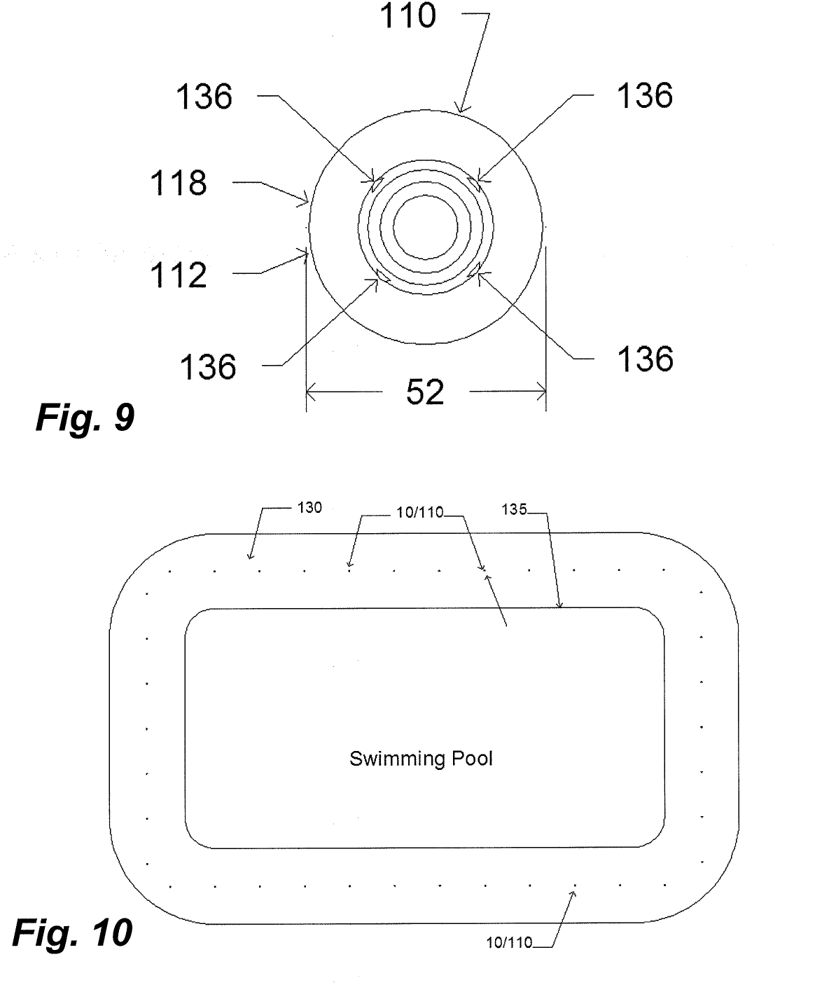

FIGS. 6A and 6B are perspective views of anchor plugs 110, 210 according to other aspects of the invention, similar to the view shown in FIG. 1. FIG. 7 is a side elevation view of the anchor plugs shown in FIGS. 6A and 6B; FIG. 8 is a top plan view of the anchor plug shown in FIGS. 6A and 6B; and FIG. 9 is a bottom view of the anchor plug shown in FIGS. 6A and 6B. Anchor plugs 110, 210 may typically have all the attributes of anchor plug 10 described above. As shown in FIGS. 6A, 6B, and 7-9, anchor plugs 110, 210 also includes a cylindrical body 112, 212 having an external surface 128, 228 and a cap 118, 218. In the aspect shown in FIGS. 6A and 6B, cap 118, 218 of anchor plug 110, 210 includes a top surface 119, 219 having some form of a graphic 120, 220, for example, one or more words, characters, graphics, or other human readable indicia. One aspect of the invention is marketed by the inventor under the trademark DEK DOT; in another aspect, a safety warning may be provided. In one aspect, at least the cap 118, 218 may comprise a color that contrasts or blends with the surrounding surface 32 (see FIGS. 5A and 5B). According to an aspect of the invention, cap 118, 218 may be enhanced by providing a color compatible with the color of the surface into which plug 110 is placed, for example, surface 32. For example, in one aspect, at least the cap 118, 218 may comprise a color that contrasts with a surrounding surface, for instance, a color, text, or graphic that boldly contrasts with the surrounding surface to enhance the visibility of plug 110, 210. In another aspect, at least the cap 118, 218 may blend with the surrounding surface 32, for example, cap 118, 218 may be of a similar color and/or texture of the surrounding surface 32 to minimize visibility of plug 110, 210. In one aspect, plug 110, 210 is so colored whereby plug 110,210 blends in with surface 32, for example, plug 110, 210 is colored concrete grey. In another aspect, plug 110, 210 is so colored whereby plug 110, 210 distinguishes from surface 32, for example, a bright yellow or orange, or a fluorescent color. In one aspect, plug 110, 210 may include a source of illumination or light, for example, an LED or florescent light. The light may be powered internally, for example, by a battery. Plug 110, 210 may also be fabricated from a phosphorescent material, that is, a material that will glow in the dark, for example, after being illuminated, for example, by sunlight. In one aspect, plug 110, 210 may also be material that changes color when exposed to light, for example, sunlight. Graphic 120, 220 may also include human readable indicia, such as, text, one or more words or phrases, for example, marketing information, for instance, the name of a pool supplier or pool cover supplier.

In another aspect of the invention, graphic 120, 220 may include information, for example, safety information, such as, the warning “NO DIVING,” “NO RUNNING,” “SHALLOW WATER,” and the like. In one aspect, the surface of cap 118, 218 may also be textured, for example, to minimize slippage by bathers or swimmers or to approximate the texture of surrounding surface 32 or texture.

As shown in FIGS. 6 through 9, in one aspect, one or more projections 136, 236 may be provided on the external surface 128, 228 of cylindrical body 112, 212. Projections, or interference features, 136, 236 may compromise radial projections that interact with the inside surface of anchor 30 to provide a snug fit when plug 10, 110, 210 is inserted into anchor 30. The projections 136, 236 may comprise a plurality of elongated radial projections elongated in the direction of elongation of the cylindrical body 112, 212.

As shown in FIGS. 7 and 9, projections 136 may vary in width and thickness along their length. For example, projections 136 may be provided with a uniform outside diameter, but, due to the typical taper of cylindrical body 112, projections 136 may vary with the taper of cylindrical body 112. In one aspect, the width and thickness of projections 136 may be substantially uniform from end to end. As shown in FIG. 9, projections 136 may be arcuate in cross section, however, in one aspect, projections 136 may have an arcuate surface, such as, a semicircular or oval cross section, or a flat surface, for example, a rectangular, square, or triangular cross section, among others.

FIG. 10 is a plan view of a typical pool deck 130 illustrating an environment in which plug 10 or 110 may be used. As shown, plug 10 or 110 may be installed in deck 130 about pool or spa 135. Again, though aspects of the invention are uniquely adaptable to use in pool decks, aspects of the invention may be inserted in anchors wherever the anchors may be located. In addition, plugs 10 or 110 may also be inserted into any hole that for which plug 10 or 110 provides some benefit, for example, for filling, concealing, and/or distinguishing the hole from its surroundings.

The size of plugs 10 and 110 may vary broadly depending upon the size of the anchor into which the plug is to be inserted. As shown in FIG. 2, the height 50 of plug 10 may vary from about 0.25 inches to about 6 inches, but is typically between about 0.5 inches and about 1.5 inches, for example, about 1 inch. The outside diameter 25 of cylindrical body 12 may vary from about 0.125 inches to about 3 inches, but is typically between about 0.25 inches and about 1 inch, for example, about 0.5 inches. The diameter 52 of cap 18 may vary from about 0.5 inches to about 5 inches, but is typically between about 1 inch and about 2 inches, for example, about 1 inch.

Anchor plugs 10 and 110 may be made from a broad range of materials, for example, metallic or non-metallic materials, including wood. Preferably, plugs 10 and 110 are made from plastic, for example, a polyamide (PA), for example, nylon; a polyamide-imide; a polyethylene (PE); a polypropylene (PP); a polyester (PE); a polytetraflouroethylene (PTFE); an acrylonitrile butadiene styrene (ABS); an acrylonitrile styrene acrylate (ASA), such as Luran ASA; a polycarbonate (PC); or a vinyl, such as, polyvinylchloride (PVC), among other plastics.

Aspects of the present invention provide an anchor plug that can be used to conceal anchors when the anchors are not in use. These anchors may be positioned in any horizontal or vertical surface to conceal a broad range of holes, in addition to anchors, but are uniquely adapted for use in concealing anchors in pool decks.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An anchor plug adapted to be inserted into an anchor, the anchor plug comprising:
a cylindrical body having a first end and a second end; and
a cap mounted to the first end of the cylindrical body.

2. The anchor plug as recited in claim 1, wherein the cap comprises a thickness that varies to a minimum at an edge of the cap.

3. The anchor plug as recited in claim 1, wherein the cylindrical body comprises a hollow cylindrical body.

4. The anchor plug as recited in claim 1, wherein the cylindrical body comprises a circular cylindrical body.

5. The anchor plug as recited in claim 4, wherein the circular cylindrical body comprises a tapered circular cylindrical body.

6. The anchor plug as recited in claim 5, wherein the tapered cylindrical body comprises a first diameter at the first end and a second diameter, smaller than the first diameter, at the second end.

7. The anchor plug as recited in claim 1, wherein the cylindrical body comprises at least one relief groove.

8. The anchor plug as recited in claim 1, wherein the cap comprises a circular cap.

9. The anchor plug as recited in claim 8, wherein the thickness the circular cap varies radially from a maximum at the center to a minimum at an outside diameter.

10. The anchor plug as recited in claim 1, where the second end of the cylindrical body comprises and open second end.

11. The anchor plug as recited in claim 1, where the cylindrical body comprises at least one projection.

12. The anchor plug as recited in claim 11, where the at least one projection comprises a plurality of radial projections from the cylindrical body.

13. The anchor plug as recited in claim 11, where the at least one projection comprises a plurality of elongated radial projections elongated in the direction of elongation of the cylindrical body.

14. The anchor plug as recited in claim 1, wherein the anchor is adapted to be inserted in a masonry anchor.

15. The anchor plug as recited in claim 1, wherein the cap includes human-readable indicia.

16. The anchor plug as recited in claim 15, wherein the human-readable indicia comprise one of one or more words and a graphic.

17. The anchor plug as recited in claim 1, wherein the cap is textured to minimize slipping by bathers.

18. The anchor plug as recited in claim 1, wherein at least the cap comprises a color that contrasts with a surrounding surface.

19. The anchor plug as recited in claim 1, wherein at least the cap comprises a color that blends with a surrounding surface.

20. The anchor plug as recited in claim 1, wherein the anchor plug further comprises a source of illumination.
